(19) United States
(12) Patent Application Publication
(10) Pub. No.: US 2019/0394709 A1
(43) Pub. Date: Dec. 26, 2019

(54) METHOD AND DEVICE FOR DETERMINING SYSTEM PARAMETERS, TERMINAL, AND BASE STATION

(71) Applicant: ZTE CORPORATION, Shenzhen, Guangdong (CN)

(72) Inventors: Weiwei YANG, Shenzhen (CN); Bo DAI, Shenzhen (CN); Kun LIU, Shenzhen (CN); Xianming CHEN, Shenzhen (CN); Huiying FANG, Shenzhen (CN)

(21) Appl. No.: 16/481,342

(22) PCT Filed: Dec. 29, 2017
(86) PCT No.: PCT/CN2017/120329

§ 371 Date: Jul. 26, 2019

(30) Foreign Application Priority Data
Jan. 26, 2017 (CN) 201710061641.1

(51) Int. Cl. H04W 48/10; H04W 48/16

(52) U.S. Cl. CPC H04W 48/10; H04W 48/16

(57) ABSTRACT

Provided is a method for determining system parameters, and the method includes: acquiring a system parameter indication field included in a master information block (MIB); and determining a first system parameter according to the system parameter indication field.

### TECHNICAL FIELD

The present disclosure relates to the field of communication technologies and, in particular, to a method and device for determining system parameters, a terminal, and a base station.

### BACKGROUND

With the development of wireless communication technology, the demand for traffic, the number of terminals and the type of terminals in mobile network applications have all shown an explosive growth trend. The 5th Generation (5G) mobile communication technology has become a trend of future network development. As one of 5G's important scenes and technologies, machine type communication (MTC) is receiving more and more attention.

The MTC, also referred to as Machine to Machine (M2M), is a primary application form of the Internet of Things in the current stage. The MTC devices deployed in the market are generally based on the Global System of Mobile communication (GSM) System. Several technologies suitable for the Comb-Internet of Things (C-IOT) have been disclosed in the technical report TR45.820V200 of the 3rd Generation Partnership Project (3GPP), among which the Narrow Band-Internet of Things (NB-IOT) technology is the most attractive. The NB-IoT system focuses on radio frequency (RF) access technologies with low complexity and low throughput, whose main research objects include the improved indoor coverage, support for a massive number of low-throughput user equipments, low delay sensitivity, ultra-low equipment costs, low equipment power consumption and network architecture. The uplink and downlink transmission bandwidths of the NB-IoT system are both 180 kHz, which are the same as the bandwidth of a physical resource block (PRB) in the Long Term Evolution (LTE) system, which facilitates the reuse of related designs of the existing LTE system in the NB-IoT system. In addition, the NB-IoT system supports three different operation modes: (1) a standalone operation which, for example, uses a frequency spectrum used by the GSM EDGE radio access network (GERAN) system to replace one or more GSM carriers, where the EDGE is the Enhanced Data rate for GSM Evolution; (2) a guard-band operation which, for example, uses an unused resource block within an LTE carrier guard-band range; and (3) an in-band operation which, for example, uses a resource block within a normal LTE carrier.

Similar to the LTE system, the system information of the NB-IOT system includes a master information block-NarrowBand (MIB-NB) and multiple system information blocks-NarrowBand (SIBs), where the MIB-NB carries main system parameters and parameters related to SIB1-NB message transmission through a narrowband physical broadcast channel (NPBCH). The SIB type in the NB-IOT system in the Release 13 includes an SIB1-NB message, an SIB2-NB information unit, an SIB3-NB information unit, an SIB4-NB information unit, an SIB5-NB information unit, an SIB14-NB information unit and an SIB16-NB information unit, where information units except the SIB1-NB form multiple SI messages which are carried by a narrowband Physical downlink shared channel (NPDSCH). The SIB1-NB message includes information required for a terminal to access a cell, and also includes scheduling information of other system messages. The SIB2-NB information unit includes common radio resource configuration information of all user equipments (UE), such as configuration information of a narrowband physical random access channel (PRACH). The information of the SIB3-NB information unit, the SIB4-NB information unit and SIB5-NB information unit information includes information related to cell reselection. The SIB14-NB information unit information includes parameters related to access barring (AB). The SIB16-NB information unit information includes information related to Global Positioning System (GPS) time and Coordinated Universal Time (UTC), and the terminal acquires the UTC, GPS and local time through such information. Generally, the terminal acquires at least one of the system message or the system parameter carried in the information unit only after receiving various system information. This process requires a lot of time, and once one of the system parameters is changed, the terminal needs to acquire the system information again, which increases the power consumption of the terminal.

### SUMMARY

The present disclosure provides a method and device for acquiring system parameters, a terminal and a base station, so as to reduce the power consumption of the terminal.

The present disclosure provides a method for determining system parameters. The method may include steps described below.

A system parameter indication field included in a master information block (MIB) is acquired.

A first system parameter is determined according to the system parameter indication field.

Optionally, the step in which the first system parameter is determined according to the system parameter indication field includes at least one of steps described below.

Whether the first system parameter is changed is determined according to the system parameter indication field; or a value of the first system parameter is determined according to the system parameter indication field.

Optionally, the step in which whether the first system parameter is changed is determined according to the system parameter indication field includes at least one of steps described below.

When it is determined according to the system parameter indication field that the first system parameter is changed, the first system parameter is acquired by receiving system information; or when it is determined according to the system parameter indication field that the first system parameter is not changed, the stored first system parameter is acquired.

Optionally, the step in which the value of the first system parameter is determined according to the system parameter indication field includes a step described below.

A k-th group of optional values in K groups of optional values is determined as the value of the first system parameter according to the system parameter indication field, where the K groups of optional values are stored or contained in the MIB, where K is a positive integer greater than or equal to 1, and k is one of 1 to K.

Optionally, the first system parameter includes at least one of: a system information block 1 (SIB1) message and at least one SIBx information unit, where the SIBx includes at least one of an SIB2, an SIB3, an SIB4, an SIB5, an SIB14 and an SIB16; at least one of an information unit or a system parameter. The information unit is required by a terminal to initially access a system, and the system parameter is required by the terminal to initially access the system; at least one of an information unit or a system parameter. The information unit is required by a terminal for cell reselection and the system parameter is required by the terminal for cell selection; at least one of an information unit or a system parameter. The information unit is required by a terminal to receive a paging message and the system parameter is required by the terminal to receive the paging message; L predefined information units, where L is a positive integer greater than or equal to 1; or N predefined system parameters, where N is a positive integer greater than or equal to 1.

The present disclosure further provides a device for determining system parameters. The device may include an acquisition module and a determination module.

The acquisition module is configured to acquire a system parameter indication field included in an MIB.

The determination module is configured to execute at least one of: determining whether the first system parameter is changed according to the system parameter indication field; or determining a value of the first system parameter according to the system parameter indication field.

Optionally, the device further includes a processing module. The processing module is configured to execute at least one of: when it is determined according to the system parameter indication field that the first system parameter is changed, acquiring the first system parameter after system information is received; or when it is determined according to the system parameter indication field that the first system parameter is not changed, using a stored first system parameter.

Optionally, the determination module is configured to determine a k-th group of optional values in K groups of optional values as the value of the first system parameter according to the system parameter indication field, where the K groups of optional values are stored or contained in the MIB, where K is a positive integer greater than or equal to 1, and k is one of 1 to K.

Optionally, the first system parameter includes at least one of: an SIB 1 message and at least one SIBx information unit, where the SIBx includes at least one of an SIB2, an SIB3, an SIB4, an SIB5, an SIB14 and an SIB16; at least one of an information unit or a system parameter, where the information unit is required by a terminal to initially access a system and the system parameter is required by the terminal to initially access the system; at least one of an information unit or a system parameter, where the information unit is required by a terminal for cell reselection and the system parameter is required by the terminal for cell selection; at least one of an information unit or the system parameter, where the information unit is required by a terminal to receive a paging message and the system parameter is required by the terminal to receive the paging message; L predefined information units, where L is a positive integer greater than or equal to 1; or N predefined system parameters, where N is a positive integer greater than or equal to 1.

The present disclosure further provides a terminal. The terminal may include a memory and a processor. The memory is configured to store following instructions: acquiring a system parameter indication field included in an MIB, and determining a first system parameter according to the system parameter indication field. The processor is configured to execute the instructions stored in the memory.

Optionally, determining the first system parameter according to the system parameter indication field includes at least one of: determining whether the first system parameter is changed according to the system parameter indication field; or determining a value of the first system parameter according to the system parameter indication field.

Optionally, determining whether the first system parameter is changed according to the system parameter indication field includes at least one of: when it is determined according to the system parameter indication field that the first system parameter is changed, acquiring the first system parameter by receiving system information; or when it is determined according to the system parameter indication field that the first system parameter is not changed, using the stored first system parameter.

Optionally, determining the value of the first system parameter according to the system parameter indication field includes: determining a k-th group of optional values in K groups of optional values as the value of the first system parameter according to the system parameter indication field, where the K groups of optional values are stored or contained in the MIB, where K is a positive integer greater than or equal to 1, and k is one of 1 to K.

Optionally, the first system parameter includes at least one of: an SIB1 message and at least one SIBx information unit, where the SIBx includes at least an SIB2, an SIB3, an SIB4, an SIB5, an SIB14 and an SIB16; at least one of an information unit or a system parameter, where the information unit is required by a terminal to initially access a system and the system parameter is required by the terminal to initially access the system; at least one of an information unit or a system parameter, where the information unit is required by a terminal for cell reselection and the system parameter is required by the terminal for cell selection; at least one of an information unit or a system parameter, where the information unit is required by a terminal to receive a paging message and the system parameter is required by the terminal to receive the paging message; L predefined information units, where L is a positive integer greater than or equal to 1; or N predefined system parameters, where N is a positive integer greater than or equal to 1.

The present disclosure further provides a method for transmitting system parameters. The method may include a step described below.

An MIB including a system parameter indication field is transmitted, where the system parameter indication field is configured to indicate a first system parameter.

Optionally, the system parameter indication field being configured to indicate the first system parameter includes one of steps described below.

The system parameter indication field indicates whether the first system parameter is changed; or the system parameter indication field indicates a value of the first system parameter.

Optionally, the first system parameter includes at least one of: an SIB 1 message and at least one SIBx information unit, where the SIBx includes at least one of an SIB2, an SIB3, an SIB4, an SIB5, an SIB14 and an SIB16; at least one of an information unit or a system parameter, where the information unit is required by a terminal to initially access a system and the system parameter is required by the terminal to initially access the system; at least one of an information unit or a system parameter, where the information unit is required by a terminal for cell reselection and the system parameter is required by the terminal for cell selection; at least one of an information unit or a system parameter, where the information unit is required by a terminal to receive a paging message and the system parameter is required by the terminal to receive the paging message; L predefined information units, where L is a positive integer greater than or equal to 1; or N predefined system parameters, where N is a positive integer greater than or equal to 1.

The present disclosure further provides a device for transmitting system parameters. The device includes a transmission module.

The transmission module is configured to transmit an MIB including a system parameter indication field, where the system parameter indication field is configured to indicate a first system parameter.

The present disclosure further provides a base station. The base station may include a memory and a processor.

The memory is configured to store a following instruction: transmitting an MIB including a system parameter indication field, where the system parameter indication field is configured to indicate a first system parameter.

The processor is configured to execute the instruction stored in the memory.

The present disclosure provides a method and device for determining system parameters, a terminal and a base station, which may enable the terminal to acquire the system parameters without necessarily acquiring all system information, so as to process the channel or the signal subsequently, thereby saving the power consumption of the terminal.

### BRIEF DESCRIPTION OF DRAWINGS

FIG. 1 is a flowchart of a method for determining system parameters according to an embodiment of the present disclosure.

FIG. 2 is a flowchart of a method for transmitting system parameters according to an embodiment of the present disclosure.

FIG. 3a is a schematic diagram of a device for determining system parameters according to an embodiment of the present disclosure.

FIG. 3b is a structural diagram of a terminal according to an embodiment of the present disclosure.

FIG. 4a is a schematic diagram of a device for transmitting system parameters according to an embodiment of the present disclosure.

FIG. 4b is a structural diagram of a base station according to an embodiment of the present disclosure.

### DETAILED DESCRIPTION

The terms “first”, “second” and the like in the specification, claims and above drawings of the present disclosure are used to distinguish between similar objects and are not necessarily used to describe a particular order or sequence.

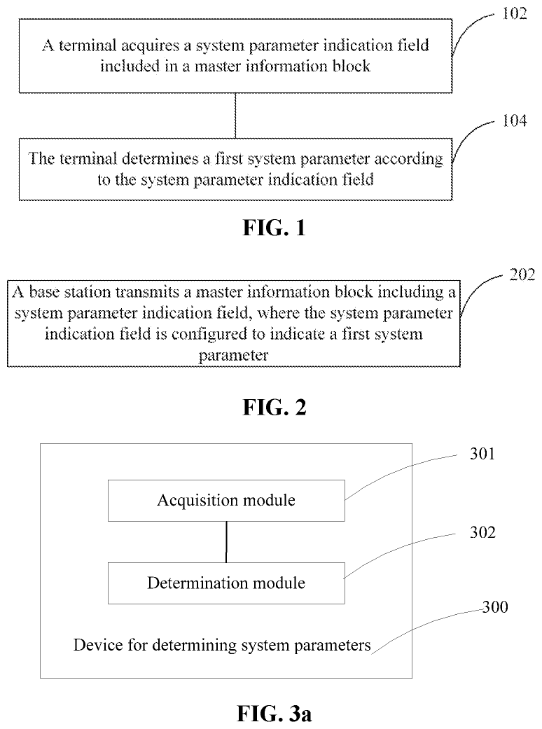

An embodiment of the present disclosure provides a method for determining system parameters. FIG. 1 is a flowchart of a method for determining system parameters according to an embodiment of the present disclosure. As shown in FIG. 1, the method may include steps 102 and 104.

In step 102, a terminal acquires a system parameter indication field included in a master information block (MIB).

In step 104, the terminal determines a first system parameter according to the system parameter indication field.

For example, a terminal receives information sent by a physical broadcast channel (PBCH), and acquires the system parameter indication field in the MIB; and the terminal determines the first system parameter according to the system parameter indication field.

The step in which the terminal determines the first system parameter according to the system parameter indication field may include at least one of following steps: the terminal determines whether the first system parameter is changed according to the system parameter indication field; or the terminal determines a value of the first system parameter according to the system parameter indication field.

The step in which the terminal determines whether the first system parameter is changed according to the system parameter indication field may include at least one of following steps: when it is determined that the first system parameter is changed according to the system parameter indication field, the terminal acquires the first system parameter by receiving system information; or when it is determined that the first system parameter is not changed according to the system parameter indication field, the terminal uses the stored first system parameter.

The step in which the terminal determines the value of the first system parameter according to the system parameter indication field may include a following step: the terminal stores K groups of values, such as {first value of the first system parameter, second value of the first system parameter, . . . , and k-th value of the first system parameter}, and the system parameter indication field indicates the first system parameter k-th value as the value of the first system parameter, where K is a positive integer greater than or equal to 1, and k is one of 1 to K.

The value of the first system parameter determined by the terminal according to the system parameter indication field is the k-th value of the first system parameter, and if the k-th value of the first system parameter is a value that is stored by the terminal, the terminal processes a channel or a signal according to the stored k-th value of the first system parameter. If the k-th value of the first system parameter is a value which is not stored by the terminal, the terminal receives system information, processes the channel or the signal according to the k-th value of the first system parameter stored in the received system information, and stores the k-th value of the first system parameter.

The step in which the terminal determines the value of the first system parameter according to the system parameter indication field may include a following step: the MIB provides K groups of optional values, such as {first value of the first system parameter, second value of the first system parameter, . . . , and k-th value of the first system parameter}, and the system parameter indication field indicates the k-th value of the first system parameter as the value of the first system parameter.

The first system parameter may be a system information block 1 (SIB1) message and at least one of SIBx information units. That is, the first system parameter includes the SIB1 message and at least one SIBx information unit, where the SIBx at least includes an SIB2, an SIB3, an SIB4, an SIB5, an SIB14 and an SIB16.

Alternatively, the first system parameter may be an information unit and/or a system parameter required when the terminal initially accesses a system. That is, the first system parameter includes at least one of the information unit required by the terminal to initially access the system or the system parameter required by the terminal to initially access the system.

Alternatively, the first system parameter may further be an information unit and/or a system parameter required by the system for cell reselection. That is, the first system parameter includes at least one of the information unit required by the terminal for cell reselection or the system parameter required by the terminal for cell selection.

Alternatively, the first system parameter may be an information unit and/or a system parameter required by the terminal to receive a paging message. That is, the first system parameter includes at least one of the information unit required by the terminal to receive the paging message or the system parameter required by the terminal to receive a paging message.

Alternatively, the first system parameter may further include L predefined information units, where L is a positive integer greater than or equal to 1.

Alternatively, the first system parameter may further include N predefined system parameters, where N is a positive integer greater than or equal to 1.

In this embodiment, the terminal acquires the first system parameter without necessarily acquiring all system information, thereby saving the power consumption of the terminal.

An embodiment of the present disclosure provides a method for transmitting system parameters. FIG. 2 is a flowchart of a method for transmitting system parameters according to an embodiment of the present disclosure. As shown in FIG. 2, the method may include a step 202.

In step 202, a base station transmits an MIB including a system parameter indication field, where the system parameter indication field is configured to indicate a first system parameter.

For example the base station may transmit the MIB through the PBCH, where the MIB carries the system parameter indication field.

The system parameter indication field being configured to indicate the first system parameter includes at least one of following.

The system parameter indication field indicates whether the first system parameter is changed; or the system parameter indication field indicates a value of the first system parameter.

Assuming that the system parameter indication field is one bit, the step in which the system parameter indication field indicates whether the first system parameter is changed may include at least one of following steps.

When the system parameter is changed, the value of the system parameter indication field is a first value; or when the system parameter is not changed, the value of the system parameter indication field is a second value; or when the system parameter is changed, a current value of the system parameter indication field is different from a value of the system parameter indication field previously sent; and when the system parameter is not changed, the current value of the system parameter indication field is the same as the value of the system parameter indication field previously sent.

Assuming that the system parameter indication field is H bits, where H is an integer greater than or equal to 1, the step in which the system parameter indication field indicates whether the first system parameter is changed may include at least one of following steps.

When the system parameter is changed, the current value of the system parameter indication field is the value of the system parameter indication field previously sent plus 1; or when the system parameter is not changed, the current value of the system parameter indication field is the same as the value of the system parameter indication field previously sent.

Assuming that the system parameter indication field is Z bits, the step in which the system parameter indication field indicates whether the first system parameter is changed may include: dividing validity duration T of the system message into Z time intervals t, and each of the Z time intervals corresponds to 1 bit; that is, each of the Z bits represents whether the first system parameter is changed within one time interval.

The base station may carry K groups of optional system parameter values through the MIB, such as {the first value of the first system parameter, the second value of the first system parameter, . . . , and the k-th value of the first system parameter}, the system parameter indication field may indicate the k-th value of the first system parameter as the value of the first system parameter, and the terminal selects a group of system parameter values among the K groups of optional system parameter values in the MIB according to the system parameter indication field, where K is an integer greater than or equal to 1.

Assuming that the system parameter indication field is F bits, 2\hat{ }F states corresponding to the system parameter indication field indicate different values of the first system parameter respectively, where F is an integer greater than or equal to 1, and 2\hat{ }F is an Fth power of 2.

The first system parameter is at least one of: an SIB1 message and at least one SIBx information unit, where the SIBx includes at least an SIB2, an SIB3, an SIB4, an SIB5, an SIB14 and an SIB16; at least one of an information unit required by a terminal to initially access a system or a system parameter required by the terminal to initially access the system; at least one of an information unit required by a terminal for cell reselection or a system parameter required by the terminal for cell selection; at least one of an information unit required by a terminal to receive a paging message or a system parameter required by the terminal to receive the paging message; L predefined information units, where L is a positive integer greater than or equal to 1; and N predefined system parameters, where N is a positive integer greater than or equal to 1.

The method in the above embodiments is described in conjunction with embodiments described below.

### Embodiment 1

It is assumed that the first system parameter is one of parameters carried in the SIB1 message, or the first system parameter is the SIB1 message and the SIB2 information unit, or the first system parameter is the information unit required by the terminal to access the system, such as a channel unit related to a physical random access channel (RACH) process and a paging process: an RACH-configCommon-r13 channel unit, an NPRACH-ConfigSIB-r13 channel unit, a PCCH-config-r13 channel unit and the like.

It is assumed that the first system parameter is L predefined information units. For example, the base station and the terminal pre-define the first system parameter as an NPDSCH-ConfigCommon channel unit, an NPUSCH-ConfigCommon channel unit and an uplinkPowerControlCommon-NB-r13 channel unit, or the first system parameter pre-defined by the base station and the terminal is common radio resource configuration information (a Radio Resource Config Common) SIB channel unit. The information unit included in the Radio Resource Config Common SIB-NB may have RACH-configCommon-r13, BCCH-config-r13, PCCH-config-r13, NPRACH-ConfigSIB-r13, NPDSCH-ConfigCommon-r13, NPUSCH-ConfigCommon-r13, DL-GapConfig-r13 and UplinkPowerControlCommon-r13, i.e., multiple information units are recombined as a new information unit.

The first system parameter may also be N predefined system parameters, i.e., multiple system parameters are recombined as a new system parameter.

### Embodiment 2

The terminal acquires the MIB of the system information: if the system parameter indication field is configured to indicate whether the system parameter is changed. The first system parameter is described by using the information unit, NPRACH-ConfigSIB-NB, as an example, as shown in examples 1 to 4.

### Example 1

The system parameter indication field is assumed to be 1 bit, whose meaning is shown in a following table. That is, if the first system parameter is not changed, the value of the system parameter indication field transmitted by the base station is a first value, i.e., 1; and if the system parameter is changed, the value of the system parameter indication field is a second value, i.e., 0.

| Value of the system | |
|---|---|
| parameter indication | |
| field | Meaning |
| 0 | NPRACH-ConfigSIB-r13 is not changed |
| 1 | NPRACH-ConfigSIB-r13 is changed |

Assuming that the value of the system parameter indication field acquired by the terminal is 0, that is, the NPRACH-ConfigSIB-r13 is not changed, the terminal uses the stored NPRACH-ConfigSIB-r13 to process the PRACH.

Assuming that the value of the system parameter indication field acquired by the terminal is 1, that is, the NPRACH-ConfigSIB-r13 is changed, the terminal receives the system message, acquires the NPRACH-ConfigSIB-r13 according to the received system message and uses the acquired NPRACH-ConfigSIB-r13 to process the PRACH.

### Example 2

Assuming that the system parameter indication field is 1 bit, if the first system parameter is changed, the current value of the system parameter indication field transmitted by the base station is different from the value of the system parameter indication field transmitted last time, otherwise it is determined that the base station does not change the value of the system parameter indication field. That is, in a case where the value of the system parameter indication field transmitted last time is set to be 0/1, if the first system parameter is changed, the value of the system parameter indication field transmitted by the base station is 1/0, and if the first system parameter is not changed, the value of the system parameter indication field transmitted by the base station is still 0/1.

Assuming that the value of the system parameter indication field acquired by the terminal is the same as the value of the system parameter indication field stored by the terminal, that is, the NPRACH-ConfigSIB-r13 is not changed, the terminal uses the stored NPRACH-ConfigSIB-r13 to process the PRACH.

Assuming that the value of the system parameter indication field acquired by the terminal is different from the value of the system parameter indication field stored by the terminal, that is, the NPRACH-ConfigSIB-r13 is changed, the terminal receives the system message and processes the PRACH according to the NPRACH-ConfigSIB-r13 acquired in the received system message.

### Example 3

Assuming that the system parameter indication field is X bits, where the value rang of X is {0, 1, . . . , 2\hat{ }(X−1)} and 2\hat{ }(X−1) is 2 to the power of (X−1), if the first system parameter is changed, the value of the system parameter indication field transmitted by the base station is added 1, otherwise the base station does not change the value of the transmitted system parameter indication field. For example, assuming that the value of the system parameter indication field transmitted last time is 1, if the first system parameter is changed, the current value of the system parameter indication field transmitted by the base station is 2, and if the first system parameter is not changed, the current value of the system parameter indication field transmitted by the base station is still 1.

Assuming that the value of the system parameter indication field acquired by the terminal is 2 and the value of the system parameter indication field stored by the terminal is 2, that is, the NPRACH-ConfigSIB-r13 is not changed, the terminal uses the stored NPRACH-ConfigSIB-r13 to process the PRACH.

Assuming that the value of the system parameter indication field acquired by the terminal is 2 and the value of the system parameter indication field stored by the terminal is 1, that is, the NPRACH-ConfigSIB-r13 is changed, the terminal receives the system message and acquire the NPRACH-ConfigSIB-r13 according to the received system message to process the PRACH. The terminal acquires other system parameters after acquiring all system messages.

### Example 4

The terminal acquires the MIB of the system information, and determines whether the first system parameter, indicated by the system parameter indication field in the MIB, is changed. It is assumed that the system parameter indication field is Z bits. That is, the validity duration T of the system message is divided into Z time intervals t, and each time interval corresponds to 1 bit; i.e., each of the Z bits represents whether the first system parameter is changed within one time interval.

Assuming that T is 24 and t is 4, then Z is 6. If the first system parameter is changed within the third time interval, the value of the system parameter indication field within each time interval is shown in a following table.

| | Value of the system |
|---|---|
| | parameter indication |
| Time interval | field |
| First time interval | 000000 |
| Second time interval | 000000 |
| Third time interval | 000100 |
| Fourth time interval | 000100 |
| Fifth time interval | 000100 |
| Sixth time interval | 000100 |

Assuming that the UE accesses the system for the first time within the first time interval, the value of the acquired system parameter indication field is 000000, and the terminal stores the value of the first system parameter corresponding to the system parameter indication field; and when the UE accesses the system again in six time intervals, the value of the acquired system parameter indication field is 000100, and the terminal may determine that the system parameter is changed according to the value 000100 of the acquired system parameter indication field and the value 000000 of the system parameter indication field stored by the terminal. Then, the terminal receives the system message and acquires the NPRACH-ConfigSIB-r13 according to the received system message to process the PRACH.

In this example, the terminal acquires the change condition of the first system parameter when acquiring the MIB, and when the first system parameter is not changed, the terminal may perform related process before receiving all pieces of system information, thereby saving the power consumption of the terminal.

### Example 5

The terminal acquires the MIB of the system information. It is assumed that the terminal determines the value of the first system parameter according to the system parameter indication field in the MIB. The first system parameter will be described by using an information sub-unit, the NPRACH-ConfigSIB-NB, as an example.

Assuming that two group of values of the first system parameter in the MIB are for selection, i.e., {first value of NPRACH-ConfigSIB-r13, second value of NPRACH-ConfigSIB-r13}, the system parameter indication field indicates the value of the first system parameter.

Assuming that the system parameter indication field transmitted by the base station indicates {first value of NPRACH-ConfigSIB-r13}, the terminal acquires the first value of NPRACH-ConfigSIB-r13 indicated by the system parameter indication field, and uses the first value of NPRACH-ConfigSIB-r13 to process the PRACH.

Assuming that the system parameter indication field transmitted by the base station indicates {second value of NPRACH-ConfigSIB-r13}, the terminal acquires the second value of NPRACH-ConfigSIB-r13 indicated by the system parameter indication field, and uses the second value of NPRACH-ConfigSIB-r13 to process the PRACH.

In this example, the terminal may acquire the value of the first system parameter when acquiring the MIB, and perform related process according to the first parameter value. The terminal may perform the related process before receiving all pieces of system information, thereby saving the power consumption of the terminal.

### Example 6

The terminal acquires the MIB of the system information. It is assumed that the terminal determines whether the first system parameter is changed and the value of the first system parameter according to the system parameter indication field in the MIB. The first system parameter will be described by using an information sub-unit, the NPRACH-ConfigSIB-NB, as an example, and the meaning of the system parameter indication field is shown in a following table.

| Value of the system | |
|---|---|
| parameter indication | |
| field | Meaning |
| 00 | The first value of NPRACH-ConfigSIB-r13 |
| 01 | The second value of NPRACH-ConfigSIB-r13 |
| 10 | The third value of NPRACH-ConfigSIB-r13 |
| 11 | Reacquire the NPRACH-ConfigSIB-r13 |

The first value of NPRACH-ConfigSIB-r13, the second value of NPRACH-ConfigSIB-r13 and the third value of NPRACH-ConfigSIB-r13 may be system parameters stored by the terminal.

Assuming that the terminal accesses the system for the first time: if the value of the acquired system parameter indication field is 00, the terminal receives the system message, acquires and stores the first value of NPRACH-ConfigSIB-r13 according to the received system message, and processes the PRACH according to the first value of NPRACH-ConfigSIB-r13. If the value of the acquired system parameter indication field is 01, the terminal receives the system message, acquires and stores the second value of NPRACH-ConfigSIB-r13 according to the received system message, and processes the PRACH according to the second value of NPRACH-ConfigSIB-r13. If the value of the acquired system parameter indication field is 10, the terminal receives the system message, acquires and stores the third value of the NPRACH-ConfigSIB-r13 according to the received system message, and processes the PRACH according to the third value of NPRACH-ConfigSIB-r13. If the value of the acquired system parameter indication field is 11, the terminal receives the system message, and acquires the NPRACH-ConfigSIB-r13 according to the received system message to process the PRACH.

When the terminal accesses the system again: if the value of the system parameter indication field acquired by the terminal is 00, the terminal uses the first value of NPRACH-ConfigSIB-r13 stored in the terminal to process the PRACH. If the value of the system parameter indication field acquired by the terminal is 01, the terminal uses the second value of NPRACH-ConfigSIB-r13 stored in the terminal to process the PRACH. If the value of the system parameter indication field acquired by the terminal is 10, the terminal uses the third value of NPRACH-ConfigSIB-r13 stored in the terminal to process the PRACH.

In this example, the terminal, when acquiring the MIB, may not only acquire the change condition of the system parameter but also acquire the value of the system parameter according to the MIB, and perform related process according to the value of the parameter value, so the terminal may perform the related process without necessarily receiving all pieces of system information, thereby saving the power consumption of the terminal.

In the above examples, the first system parameter is described by using one information unit as an example. The first system parameter will be described by using multiple information units as an example, referred to examples 7 to 10 described below. It is assumed that the first system parameter includes the PCCH-config-r13 and the NPRACH-ConfigSIB-r13.

### Example 7

Assuming that the system parameter indication field is 1 bit, if the first system parameter is changed, the current value of the system parameter indication field transmitted by the base station is different from the value of the system parameter indication field transmitted last time, otherwise the base station does not change the value of the system parameter indication field. That is, in a case where the value of the system parameter indication field transmitted by the base station last time is 0/1, if the first system parameter is changed, the value of the system parameter indication field transmitted by the base station is 1/0, and if the first system parameter is not changed, the value of the transmitted system parameter indication field is still 0/1.

Assuming that the value of the system parameter indication field acquired by the terminal is the same as the value of the system parameter indication field stored by the terminal, that is, the NPRACH-ConfigSIB-r13 and the PCCH-config-r13 are not changed, the terminal processes the PRACH according to the stored NPRACH-ConfigSIB-r13, and processes paging information according to the stored PCCH-config-r13.

Assuming that the value of the system parameter indication field acquired by the terminal is different from the value of the system parameter indication field stored by the terminal, that is, the NPRACH-ConfigSIB-r13 and the PCCH-config-r13 are changed, the terminal receives the system message, processes the PRACH according to the changed NPRACH-ConfigSIB-r13 acquired in the received system message, and processes the paging information according to the changed PCCH-config-r13 acquired in the received system message.

### Example 8

It is assumed that the system parameter indication field is 2 bits, which respectively indicate the parameter change of the NPRACH-ConfigSIB-r13 and the PCCH-config-r13. It is assumed that the lower bit represents whether the NPRACH-ConfigSIB-r13 is changed, and the higher bit represents whether the PCCH-config-r13 is changed. If merely the NPRACH-ConfigSIB-r13 is changed, the lower bit of the current value of the system parameter indication field transmitted by the base station is different from the lower bit of the value of the system parameter indication field transmitted last time. If merely the PCCH-config-r13 is changed, the higher bit of the current value of the system parameter indication field transmitted by the base station is different from the higher bit of the value of the system parameter indication field transmitted last time. If both the NPRACH-ConfigSIB-r13 and the PCCH-config-r13 are changed, the higher bit and the lower bit of the current value of the system parameter indication field transmitted by the base station are different from the higher bit and the lower bit of the value of the system parameter indication field transmitted last time.

Assuming that the value of the system parameter indication field acquired by the terminal is the same as the value of the system parameter indication field stored by the terminal, that is, the NPRACH-ConfigSIB-r13 and the PCCH-config-r13 are not changed, the terminal processes the PRACH according to the stored NPRACH-ConfigSIB-r13, and processes the paging information according to the stored PCCH-config-r13.

Assuming that the lower bit of the value of the system parameter indication field acquired by the terminal is different from the lower bit of the value of the system parameter indication field stored by the terminal, that is, the NPRACH-ConfigSIB-r13 is changed, the terminal receives the system message and processes the PRACH according to the changed NPRACH-ConfigSIB-r13 acquired in the received system message.

Assuming that the higher bit of the value of the system parameter indication field acquired by the terminal is different from the higher bit of the value of the system parameter indication field stored by the terminal, that is, the PCCH-config-r13 is changed, the terminal receives the system message and processes the paging information according to the changed PCCH-config-r13 acquired in the received system message.

Assuming that the higher bit and the lower bit of the value of the system parameter indication field acquired by the terminal are different from the higher bit and the lower bit of the value of the system parameter indication field stored by the terminal, that is, the NPRACH-ConfigSIB-r13 and the PCCH-config-r13 are both changed, the terminal receives the system message, processes the PRACH according to the changed NPRACH-ConfigSIB-r13 acquired in the received system message, and processes the paging information according to the changed PCCH-config-r13 acquired in the received system message.

### Example 9

Assuming that a group of values of the first system parameter in the MIB are for selection, i.e., {first value of NPRACH-ConfigSIB-r13, second value of NPRACH-ConfigSIB-r13, first value of PCCH-config-r13, second value of PCCH-config-r13}, the system parameter indication field indicates the value of the first system parameter.

Assuming that the system parameter indication field transmitted by the base station indicates {first value of NPRACH-ConfigSIB-r13}, the terminal acquires the first value of NPRACH-ConfigSIB-r13 indicated by the system parameter indication field, and uses the first value of NPRACH-ConfigSIB-r13 to process the PRACH; and the terminal receives the system information, and uses the PCCH-config-r13 in the received system information to process the paging information.

Assuming that the system parameter indication field transmitted by the base station indicates {second value of NPRACH-ConfigSIB-r13}, the terminal acquires the second value of NPRACH-ConfigSIB-r13 indicated by the system parameter indication field, and uses the second value of NPRACH-ConfigSIB-r13 to process the PRACH; and the terminal receives the system information, and uses the PCCH-config-r13 in the received system information to process the paging information.

Assuming that the system parameter indication field transmitted by the base station indicates {first value of PCCH-config-r13}, the terminal acquires the first value of PCCH-config-r13 indicated by the system parameter indication field, and uses the first value of PCCH-config-r13 to process the paging information; and the terminal receives the system information, and uses the NPRACH-ConfigSIB-r13 in the received system information to process the PRACH.

Assuming that the system parameter indication field transmitted by the base station indicates {second value of PCCH-config-r13}, the terminal acquires the second value of PCCH-config-r13 indicated by the system parameter indication field, and uses the second value of PCCH-config-r13 to process the paging information; and the terminal receives the system information, and uses the NPRACH-ConfigSIB-r13 in the received system information to process the PRACH.

Assuming that the system parameter indication field transmitted by the base station indicates {first value of NPRACH-ConfigSIB-r13, second value of PCCH-config-r13}, the terminal acquires the first value of NPRACH-ConfigSIB-r13 and the second value of PCCH-config-r13 indicated by the system parameter indication field, uses the first value of NPRACH-ConfigSIB-r13 to process the PRACH, and uses the second value of PCCH-config-r13 to process the paging information.

### Example 10

It is assumed that the meaning of the system parameter indication field is shown in a following table.

| Value of the system | |
|---|---|
| parameter indication | |
| field | Meaning |
| 00 | The first value of NPRACH-ConfigSIB-r13, the |
| | first value of PCCH-config-r13 |
| 01 | The second value of NPRACH-ConfigSIB-r13, |
| | the second value of PCCH-config-r13 |
| 10 | The third value of NPRACH-ConfigSIB-r13, |
| | the third value of PCCH-config-r13 |
| 11 | Reacquire the NPRACH-ConfigSIB-r13 and the |
| | PCCH-config-r13 |

The first value of NPRACH-ConfigSIB-r13, the second value of NPRACH-ConfigSIB-r13, the third value of NPRACH-ConfigSIB-r13, the first value of PCCH-config-r13, the second value of PCCH-config-r13 and the third value of PCCH-config-r13 are system parameter values stored by the terminal.

Assuming that the terminal accesses the system for the first time: if the value of the acquired system parameter indication field is 00, the terminal receives the system message, acquires and stores the first value of NPRACH-ConfigSIB-r13 according to the received system message, and processes the PRACH according to the first value of NPRACH-ConfigSIB-r13; and acquires and stores the first value of PCCH-config-r13 according to the received system message, and processes the paging information according to the first value of PCCH-config-r13. If the value of the acquired system parameter indication field is 01, the terminal receives the system message, acquires and stores the second value of NPRACH-ConfigSIB-r13 according to the received system message, and processes the PRACH according to the second value of NPRACH-ConfigSIB-r13; and acquires and stores the second value of PCCH-config-r13 according to the received system message, and processes the paging information according to the second value of PCCH-config-r13. If the value of the acquired system parameter indication field is 10, the terminal receives the system message, acquires and stores the third value of NPRACH-ConfigSIB-r13 according to the received system message, and processes the PRACH according to the third value of NPRACH-ConfigSIB-r13; and acquires and stores the third value of PCCH-config-r13 according to the received system message, and processes the paging information according to the third value of PCCH-config-r13. If the value of the acquired system parameter indication field is 11, the terminal receives the system message, processes the PRACH according to the NPRACH-ConfigSIB-r13 acquired in the received system message, and processes the paging information according to the PCCH-config-r13 acquired in the received system message.

When the terminal accesses the system again: if the value of the system parameter indication field acquired by the terminal is 00, the terminal uses the first value of NPRACH-ConfigSIB-r13 stored in the terminal to process the PRACH, and uses the first value of PCCH-config-r13 stored in the terminal to process the paging information. If the value of the system parameter indication field acquired by the terminal is 01, the terminal uses the second value of NPRACH-ConfigSIB-r13 stored in the terminal to process the PRACH, and uses the second value of PCCH-config-r13 stored in the terminal to process the paging information. If the value of the system parameter indication field acquired by the terminal is 10, the terminal uses the third value of NPRACH-ConfigSIB-r13 stored in the terminal to process the PRACH, and uses the third value of PCCH-config-r13 stored in the terminal to process the paging information.

In this example, the terminal acquires at least one of the change condition of the first system parameter or the value of the first system parameter through the system parameter indication field in the MIB, and may acquire other system parameters after the terminal acquires all pieces of system information.

The method for determining system parameters shown in step 102 to step 104 and the method for transmitting system parameters shown in step 202 provided by the embodiments of the present disclosure are both applicable to a system that acquires system parameters only after acquiring all pieces of system information, such as an MTC system.

The MIB in step 102 (or step 202) provided in the embodiments of the present disclosure may be transmitted by the base station through the PBCH. The base station may also transmit the MIB through at least one channel. For example, the MIB is divided into two parts, i.e., the MIB 1 and the MIB 2, the MIB 1 is transmitted through the channel A, and the MIB 2 is transmitted through the channel B. If the system parameter indication field is included in the MIB, whether it is included in the MIB 1 or the MIB 2, it is within the scope of the present disclosure.

### Embodiment 3

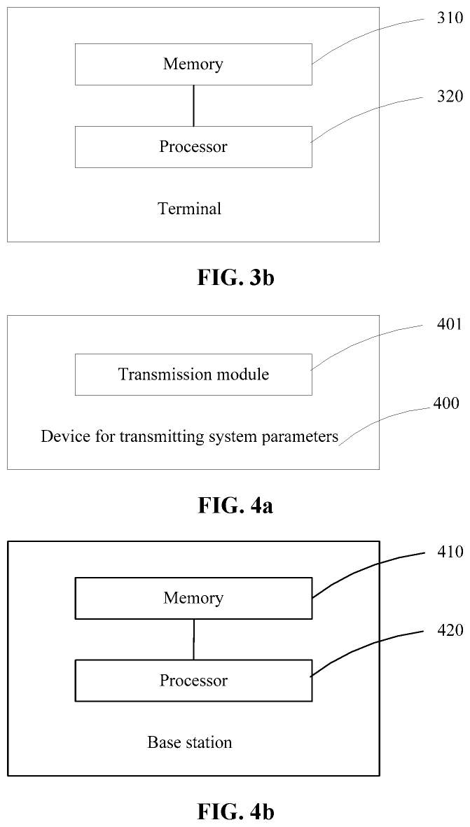

FIG. 3a is a schematic diagram of a device for determining system parameters according to an embodiment of the present disclosure. As shown in FIG. 3a, the device in this embodiment may include an acquisition module 301 and a determination module 302.

The acquisition module 301 is configured to acquire a system parameter indication field included in an MIB.

The determination module 302 is configured to determine a first system parameter according to the system parameter indication field.

The determination module 302 is configured to determine whether the first system parameter is changed according to the system parameter indication field, and determine a value of the first system parameter according to the system parameter indication field.

Optionally, the device may further include a processing module.

The processing module is configured to, when it is determined that the first system parameter is changed according to the system parameter indication field, acquire the first system parameter by receiving system information, and when it is determined that the first system parameter is not changed according to the system parameter indication field, use the stored first system parameter.

Optionally, the determination module 302 is configured to determine a k-th group of optional values in K groups of optional values as the value of the first system parameter according to the system parameter indication field, where the K groups of optional values are stored or contained in the MIB, where K is a positive integer greater than or equal to 1, and k is one of 1 to K.

The first system parameter includes an SIB1 message and at least one SIBx information unit, where the SIBx includes at least one of an 51132, an SIB3, an SIB4, an SIB5, an SIB14 and an SIB16. The first system parameter includes at least one of an information unit required by a terminal to initially access a system or a system parameter required by the terminal to initially access the system. The first system parameter includes at least one of an information unit required by a terminal for cell reselection or a system parameter required by the terminal for cell selection. The first system parameter includes at least one of an information unit required by a terminal to receive a paging message or a system parameter required by the terminal to receive the paging message. The first system parameter includes L predefined information units, where L is a positive integer greater than or equal to 1. The first system parameter includes N predefined system parameters, where N is a positive integer greater than or equal to 1.

An embodiment of the present disclosure further provides a terminal. As shown in FIG. 3b, the terminal may include a memory 310 and one or more processors 320. One processor is used as an example in FIG. 3b.

The memory 310 is configured to store following instructions: acquiring a system parameter indication field included in an MIB, and determining a first system parameter according to the system parameter indication field.

The processor 320 is configured to execute the instructions stored in the memory.

Optionally, the instruction for acquiring a system parameter indication field included in an MIB includes at least one of: determining whether the first system parameter is changed according to the system parameter indication field; or determining a value of the first system parameter according to the system parameter indication field.

Optionally, determining whether the first system parameter is changed according to the system parameter indication field includes one of: when it is determined that the first system parameter is changed according to the system parameter indication field, acquiring the first system parameter after system information is received; or when it is determined that the first system parameter is not changed according to the system parameter indication field, using the stored first system parameter.

Optionally, determining the value of the first system parameter according to the system parameter indication field includes: determining a k-th group of optional values in K groups of optional values as the value of the first system parameter according to the system parameter indication field, where the K groups of optional values are stored or contained in the MIB, where K is a positive integer greater than or equal to 1, and k is one of 1 to K.

Optionally, the first system parameter is at least one of: an SIB1 message and at least one SIBx information unit, where the SIBx includes at least an SIB2, an SIB3, an SIB4, an SIB5, an SIB14 and an SIB16; at least one of an information unit required by a terminal to initially access a system or a system parameter required by the terminal to initially access the system; at least one of an information unit required by a terminal for cell reselection or a system parameter required by the terminal for cell selection; at least one of an information unit required by a terminal to receive a paging message or a system parameter required by the terminal to receive the paging message; L predefined information units, where L is a positive integer greater than or equal to 1; or N predefined system parameters, where N is a positive integer greater than or equal to 1.

FIG. 4a is a schematic diagram of a device for transmitting system parameters according to an embodiment of the present disclosure. As shown in FIG. 4a, the device for transmitting system parameters provided by this embodiment may include a transmission module.

The transmission module is configured to transmit an MIB including a system parameter indication field, where the system parameter indication field is configured to indicate a first system parameter.

Optionally, the system parameter indication field being configured to indicate a first system parameter includes at least one of: determining whether the first system parameter is changed according to the system parameter indication field; or determining a value of the first system parameter according to the system parameter indication field.

The first system parameter includes an SIB1 message and at least one SIBx information unit, where the SIBx includes at least an SIB2, an SIB3, an SIB4, an SIB5, an SIB14 and an SIB16. The first system parameter at least includes one of an information unit required by a terminal to initially access a system or a system parameter required by the terminal to initially access the system. The first system parameter at least includes one of an information unit required by a terminal for cell reselection or a system parameter required by the terminal for cell selection. The first system parameter at least includes one of an information unit required by a terminal to receive a paging message or a system parameter required by the terminal to receive the paging message. The first system parameter includes L predefined information units, where L is a positive integer greater than or equal to 1. The first system parameter includes N predefined system parameters, where N is a positive integer greater than or equal to 1.

An embodiment of the present disclosure further provides a base station. As shown in FIG. 4b, the base station may include a memory 410 and one or more processors 420. One processor is used as an example in FIG. 4b.

The memory 410 is configured to store a following instruction: transmitting an MIB including a system parameter indication field, where the system parameter indication field is configured to indicate a first system parameter.

The processor 420 is configured to execute the instruction stored in the memory.

Optionally, the system parameter indication field being configured to indicate a first system parameter includes at least one of: determining whether the first system parameter is changed according to the system parameter indication field; or determining a value of the first system parameter according to the system parameter indication field.

The first system parameter includes an SIB1 message and at least one SIBx information unit, where the SIBx at least includes an SIB2, an SIB3, an SIB4, an SIB5, an SIB14 and an SIB16. The first system parameter includes at least one of an information unit required by a terminal to initially access a system or a system parameter required by the terminal to initially access the system. The first system parameter includes at least one of an information unit required by a terminal for cell reselection or a system parameter required by the terminal for cell selection.

The first system parameter includes at least one of an information unit required by a terminal to receive a paging message or a system parameter required by the terminal to receive the paging message. The first system parameter includes L predefined information units, where L is a positive integer greater than or equal to 1. The first system parameter includes N predefined system parameters, where N is a positive integer greater than or equal to 1.

An embodiment of the present disclosure further provides a computer-readable storage medium, which is configured to store computer-executable instructions for implementing the method for determining and transmitting system parameters when the instructions are executed.

The memory 310 and the memory 410 in the above embodiments may both include a program storage region and a data storage region. The program storage region may store an operating system and an application program required by at least one function. The data storage region may store data created according to the use of the corresponding device and the like. In addition, the memory may include, for example, a volatile memory such as a random access memory, and may also include a non-volatile memory, such as at least one disk memory, a flash memory, or other non-transient solid-state memories.

In addition, the logic instructions in the memory 310 and the memory 410 may be implemented in the form of a software functional unit and, when sold or used as an independent product, may be stored in a computer-readable storage medium. The technical solutions provided by the present disclosure may be embodied in the form of a computer software product. The computer software product may be stored in a storage medium and includes several instructions for enabling a computer device (which may be a personal computer, a server, a network device, or the like) to execute all or part of the steps in the methods according to the embodiments of the present disclosure.

The storage medium may be a non-transient storage medium, or may also be a transient storage medium. The non-transient storage medium may include a USB flash disk, a mobile hard disk, a read-only memory (ROM), a random access memory (RAM), a magnetic disk, an optical disk, or another medium capable of storing program codes.

For specific examples in this embodiment, reference may be made to the examples described in the above-mentioned embodiments and optional implementation modes, and the specific examples will not be repeated in this embodiment.

Each of the modules or steps in the embodiments described above may be implemented by a universal computing device. The modules or steps may be concentrated on a single computing device or distributed on a network composed of multiple computing devices. Optionally, the modules or steps may be implemented by program codes executable by the computing device so that the modules or steps may be stored in a storage device and executed by the computing device. In some circumstances, the illustrated or described steps may be executed in sequences different from those described herein, or the modules or steps may be made into various integrated circuit modules separately, or multiple modules or steps therein may be made into a single integrated circuit module for implementation. In this way, the present disclosure is not limited to any specific combination of hardware and software.

### INDUSTRIAL APPLICABILITY

The present disclosure provides a method and device for determining system parameters, a terminal and a base station, which may enable the terminal to acquire the system parameters without necessarily acquiring all system information, so as to process the channel or the signal subsequently, thereby saving the power consumption of the terminal.

1. A method for determining system parameters, comprising:
acquiring a system parameter indication field comprised in a master information block (MIB); and
determining a first system parameter according to the system parameter indication field.

2. The method of claim 1, wherein determining the first system parameter according to the system parameter indication field comprises at least one of:
determining whether the first system parameter is changed according to the system parameter indication field; or
determining a value of the first system parameter according to the system parameter indication field.

3. The method of claim 2, wherein the determining whether the first system parameter is changed according to the system parameter indication field comprises at least one of:
in response to determining according to the system parameter indication field that the first system parameter is changed, acquiring the first system parameter by receiving system information; or
in response to determining according to the system parameter indication field that the first system parameter is not changed, acquiring a stored first system parameter.

4. The method of claim 2, wherein the determining the value of the first system parameter according to the system parameter indication field comprises:
determining a k-th group of optional values in K groups of optional values as the value of the first system parameter according to the system parameter indication field, wherein the K groups of optional values are stored or contained in the MIB, wherein K is a positive integer greater than or equal to 1, and k is one of 1 to K.

5. The method of claim 1, wherein the first system parameter comprises at least one of:
a system information block 1 (SIB1) message and at least one SIBx information unit, wherein the SIBx at least comprises an SIB2, an SIB3, an SIB4, an SIB5, an SIB14 and an SIB16;
at least one of an information unit or a system parameter, wherein the information unit is required by a terminal to initially access a system, and the system parameter is required by the terminal to initially access the system;
at least one of an information unit or a system parameter, wherein the information unit is required by a terminal for cell reselection, and the system parameter is required by the terminal for cell selection;
at least one of an information unit or a system parameter, wherein the information unit is required by a terminal to receive a paging message, and the system parameter is required by the terminal to receive the paging message;
L predefined information units, wherein L is a positive integer greater than or equal to 1; or
N predefined system parameters, wherein N is a positive integer greater than or equal to 1.

6. A device for determining system parameters, comprising:
an acquisition module, which is configured to acquire a system parameter indication field comprised in a master information block (MIB); and
a determination module, which is configured to determine a first system parameter according to the system parameter indication field.

7. The device of claim 6, wherein
the determination module is configured to execute at least one of: determining whether the first system parameter is changed according to the system parameter indication field; or determining a value of the first system parameter according to the system parameter indication field.

8. The device of claim 6, further comprising:
a processing module, which is configured to execute at least one of: in response to determining according to the system parameter indication field that the first system parameter is changed, acquiring the first system parameter after system information is received; or in response to determining according to the system parameter indication field that the first system parameter is not changed, using a stored first system parameter.

9. The device of claim 7, wherein
the determination module is configured to determine a k-th group of optional values in K groups of optional values as the value of the first system parameter according to the system parameter indication field, wherein the K groups of optional values are stored or contained in the MIB, wherein K is a positive integer greater than or equal to 1, and k is one of 1 to K.

10. The device of claim 6, wherein the first system parameter comprises at least one of:
a system information block 1 (SIB1) message and at least one SIBx information unit, wherein the SIBx at least comprises an SIB2, an SIB3, an SIB4, an SIB5, an SIB14 and an SIB16;
at least one of an information unit or a system parameter, wherein the information unit is required by a terminal to initially access a system and the system parameter is required by the terminal to initially access the system;
at least one of an information unit or a system parameter, wherein the information unit is required by a terminal for cell reselection and the system parameter is required by the terminal for cell selection;
at least one of an information unit or a system parameter, wherein the information unit is required by a terminal to receive a paging message and the system parameter is required by the terminal to receive the paging message;
L predefined information units, wherein L is a positive integer greater than or equal to 1; or
N predefined system parameters, wherein N is a positive integer greater than or equal to 1.

11. A terminal, comprising a memory for storing instructions and a processor; wherein the processor is configured to, when executing the instructions, perform the method of claim 1.

12. The terminal of claim 11, wherein
in the instructions stored in the memory, determining the first system parameter according to the system parameter indication field comprises at least one of: determining whether the first system parameter is changed according to the system parameter indication field; and determining a value of the first system parameter according to the system parameter indication field; wherein
the step of determining whether the first system parameter is changed according to the system parameter indication field comprises one of:
in response to determining according to the system parameter indication field that the first system parameter is changed, acquiring the first system parameter after system information is received; or
in response to determining according to the system parameter indication field that the first system parameter is not changed, using a stored first system parameter; and
the step of determining the value of the first system parameter according to the system parameter indication field comprises:
determining a k-th group of optional values in K groups of optional values as the value of the first system parameter according to the system parameter indication field, wherein the K groups of optional values are stored or contained in the MIB, wherein K is a positive integer greater than or equal to 1, and k is one of 1 to K.

13. The terminal of claim 11, wherein the first system parameter comprises at least one of:
a system information block 1 (SIB1) message and at least one SIBx information unit, wherein the SIBx at least comprises an SIB2, an SIB3, an SIB4, an SIB5, an SIB14 and an SIB16;
at least one of an information unit or a system parameter, wherein the information unit is required by a terminal to initially access a system and the system parameter is required by the terminal to initially access the system;
at least one of an information unit or a system parameter, wherein the information unit is required by a terminal for cell reselection and the system parameter is required by the terminal for cell selection;
at least one of an information unit or a system parameter, wherein the information unit is required by a terminal to receive a paging message and the system parameter required by the terminal to receive the paging message;
L predefined information units, wherein L is a positive integer greater than or equal to 1; or
N predefined system parameters, wherein N is a positive integer greater than or equal to 1.

14. A method for transmitting system parameters, comprising:
transmitting a master information block (MIB) comprising a system parameter indication field, wherein the system parameter indication field is configured to indicate a first system parameter.

15. The method of claim 14, wherein the system parameter indication field being configured to indicate the first system parameter comprises at least one of:
the system parameter indication field indicating whether the first system parameter is changed; or
the system parameter indication field indicating a value of the first system parameter.

16. The method of claim 14, wherein the first system parameter comprises at least one of:
a system information block 1 (SIB1) message and at least one SIBx information unit, wherein the SIBx at least comprises an SIB2, an SIB3, an SIB4, an SIB5, an SIB14 and an SIB16;
at least one of an information unit or a system parameter, wherein the information unit is required by a terminal to initially access a system and the system parameter is required by the terminal to initially access the system;
at least one of an information unit or a system parameter, wherein the information unit is required by a terminal for cell reselection and the system parameter is required by the terminal for cell selection;
at least one of an information unit or a system parameter, wherein the information unit is required by a terminal to receive a paging message and the system parameter is required by the terminal to receive the paging message;
L predefined information units, wherein L is a positive integer greater than or equal to 1; or
N predefined system parameters, wherein N is a positive integer greater than or equal to 1.

17. (canceled)

18. A base station, comprising a memory for storing instructions and a processor; wherein the processor is configured to, when executing the instructions, perform the method of claim 14.

19. A non-transitory computer-readable storage medium, which is configured to store computer-executable instructions for executing the method of any one of claim 1.

20. A non-transitory computer-readable storage medium, which is configured to store computer-executable instructions for executing the method of claim 14.

21. The method of claim 2, wherein the system parameter indication field is one bit and represents whether the first system parameter is changed within validity duration T.
